(19) United States
(12) Patent Application Publication
(10) Pub. No.: US 2003/0029826 A1
(43) Pub. Date: Feb. 13, 2003

(54) Ring lift crane

(76) Inventors: Eberhard Schuffert, Homberg (DE); Rudiger Zollondz, Hornbach (DE)

Correspondence Address: Thomas C Pontani, Cohen Pontani Lieberman & Pavane, Suite 1210, 551 Fifth Avenue, New York, NY, 10176, US

(21) Appl. No.: 10/168,923

(22) PCT Filed: Jan. 18, 2001
(86) PCT No.: PCT/DE01/00253

(30) Foreign Application Priority Data
Jan. 19, 2000 (DE) 100 02 917.5

(51) Int. Cl. B66C 23/72

(52) U.S. Cl. 212/301

(57) ABSTRACT

The invention is directed to a ring lift crane with a liftable ring forming a circular traveling path and having a plurality of segments which can be connected to one another. Within the ring, there is arranged a chassis having a superstructure which is connected with the chassis so as to be rotatable and which has a plurality of winches. The superstructure is provided with an adapter in each of two oppositely located end areas, and the adapters are supported in a rolling manner on the circular traveling path of the ring by rollers which are arranged in the end area of the adapters. The center of the ring and chassis forms the axis of rotation and the rear adapter is constructed so as to receive a counterweight and the front adapter is constructed so as to receive a boom in the form of a lattice mast which can be articulated and which has at least one main boom, and means are provided for generating the rotating movement of the ring lift crane, and the chassis is connected with different segments of the ring by reinforcement members. A lateral reinforcement is provided at least one a lattice mast component and extends along at least one half of the length of the lattice mast component.

The present invention is directed to a ring lift crane according to the preamble of patent claim 1.

A ring lift crane of the type mentioned above is known from DE 199 14 195 A1. This known ring lift crane is provided with a liftable ring forming a circular traveling path and having a plurality of segments which can be connected to one another. Within the ring, there is arranged a chassis having a superstructure which is connected with the chassis so as to be rotatable and which has a plurality of winches. The chassis also has two bridge girders extending parallel to and at a distance from one another. Each bridge girder is provided with an adapter in two oppositely located end areas and can be bolted to or unbolted from the superstructure via cross-girders. The adapters are supported on the circular traveling path of the ring by means of rollers arranged in the end area of the adapters. The center of the ring and chassis forms the axis of rotation. The rear adapter is constructed so as to receive a counterweight and the front adapter is constructed so as to receive a boom in the form of a lattice mast which can be articulated, has at least one main boom and is provided with means for generating the rotating movement of the ring lift crane. The chassis is connected with different segments of the ring by reinforcement members.

This known ring lift crane has limited lifting capacity because it can not transmit larger forces.

It is the object of the invention to provide a ring lift crane of the type mentioned above whose lifting capacity can be significantly increased in a simple manner.

Proceeding from the preamble, this object is met in connection with the characterizing features of claim 1. Advantageous further developments are contained in the subclaims.

According to the teaching of the invention, a lateral reinforcement is provided at least at one lattice mast component (main boom, fly jib, mast, luffing support) and extends along at least one half of the length of the lattice mast component. The main boom preferably has a lateral reinforcement whose foot end, like the foot end of the main boom, is connected in an articulated manner with the front adapter and whose head end is fixedly connected with an element of the main boom. In order to achieve maximum effect, the lateral reinforcement extends over the entire length of the main boom, so that the head end of the reinforcement is fixedly connected with the head piece of the main boom. The suggested principle of the arrangement of a lateral reinforcement is also advantageous for other lattice mast components such as a mast, fly jib and luffing support. The lateral reinforcement comprises at least one anchoring element which is arranged to the right and to the left at a distance to and parallel to the respective lattice mast component and which is connected at defined intervals via connection elements to the respective lattice mast element. For purposes of a particularly effective reinforcement, it can be advantageous when two anchoring elements, instead of one anchoring element, are provided per side. The connection between the anchoring element and the lattice mast element is preferably constructed as an isosceles triangle, the distance of the anchoring element from the lattice mast element corresponding at least to one half of the width of the lattice mast element. Depending on the design of the overall construction, the distance can also correspond to two- to four-times the width.

The suggested arrangement results in a reinforcement of the respective lattice mast component, preferably of the main boom in both lateral directions, and the arrangement can be tensile loaded or compression loaded when bars or tube are used as anchoring elements. In another feature of the invention, as an alternative to lateral anchoring, lifting capacity can be increased in that the mast is constructed as a double-mast whose foot pieces are connected in an articulated manner to the front adapter. This also applies to a combination of double-main boom without lateral reinforcement in connection with a fly jib which is provided with a lateral reinforcement.

Further features, advantages and details of the invention result from the following description of an embodiment example shown in a drawing.

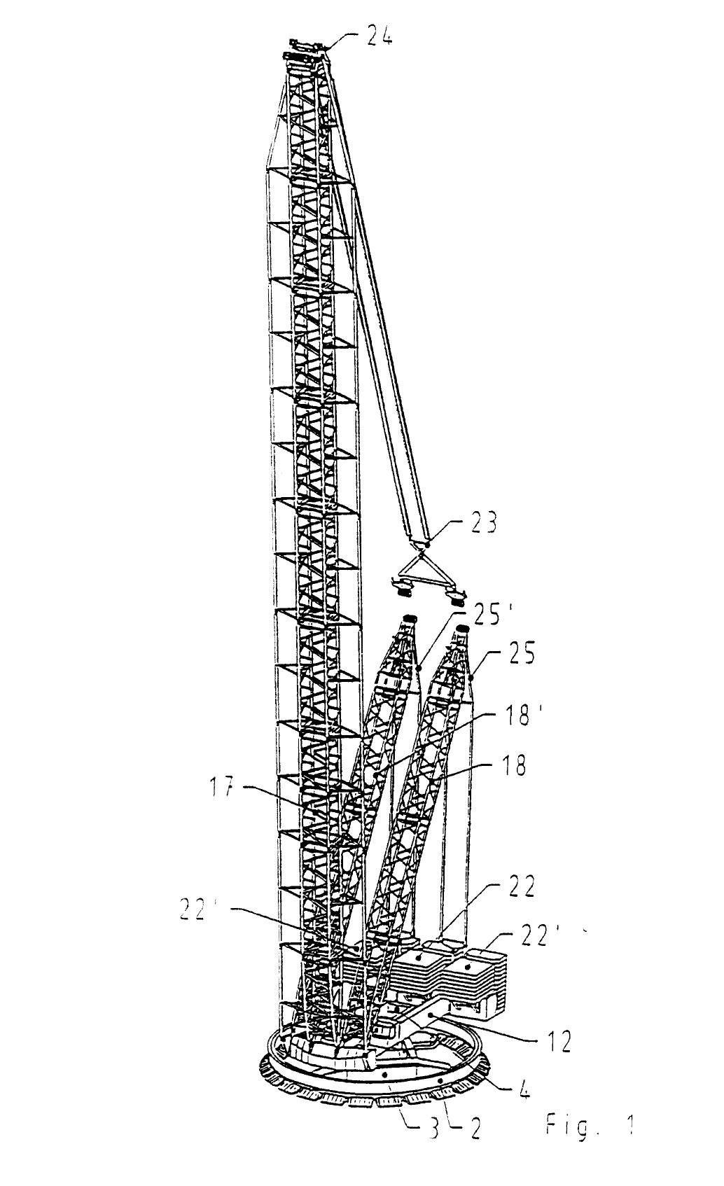

FIG. 1 is a perspective view of a ring lift crane which is constructed according to the invention;

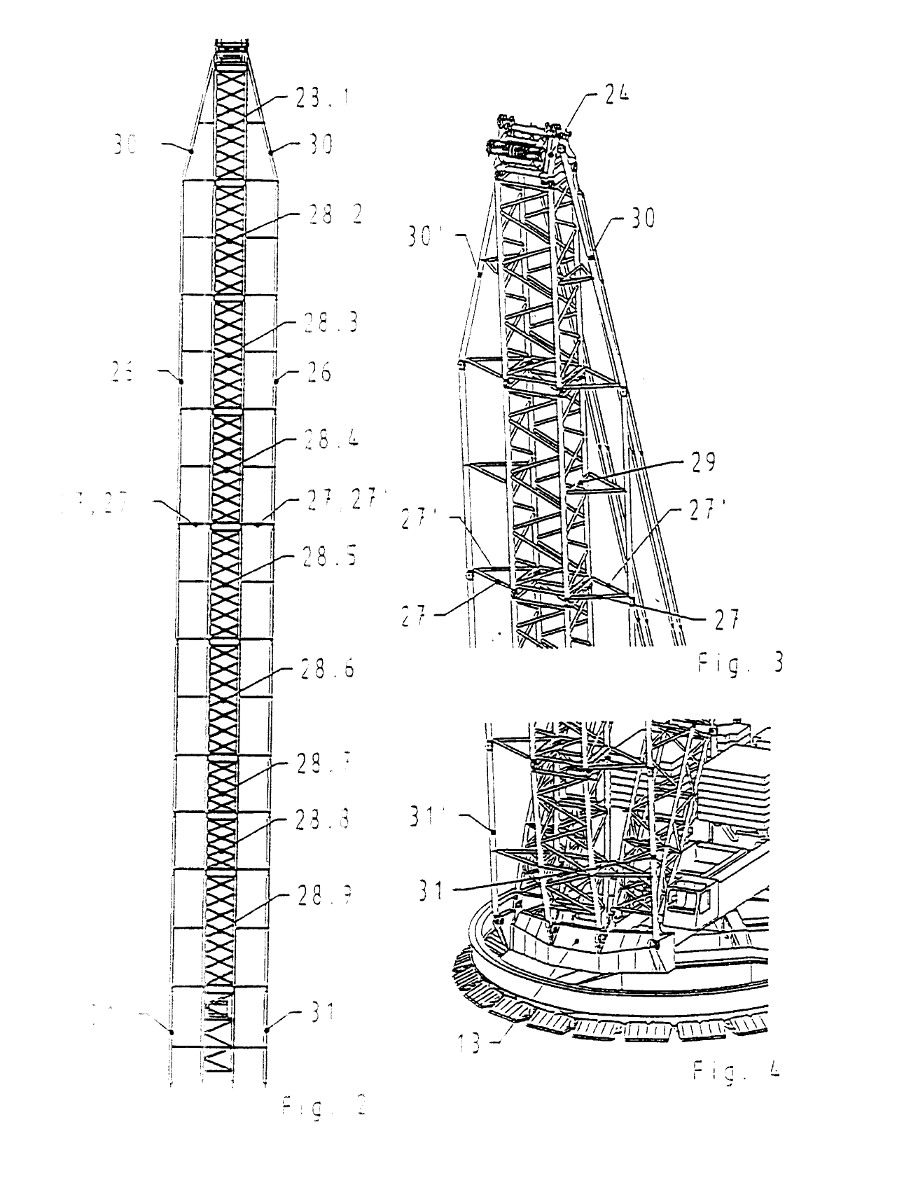

FIG. 2 is a front view in partial section showing the main boom;

FIG. 3 is a view in enlarged scale showing the head area of the main boom;

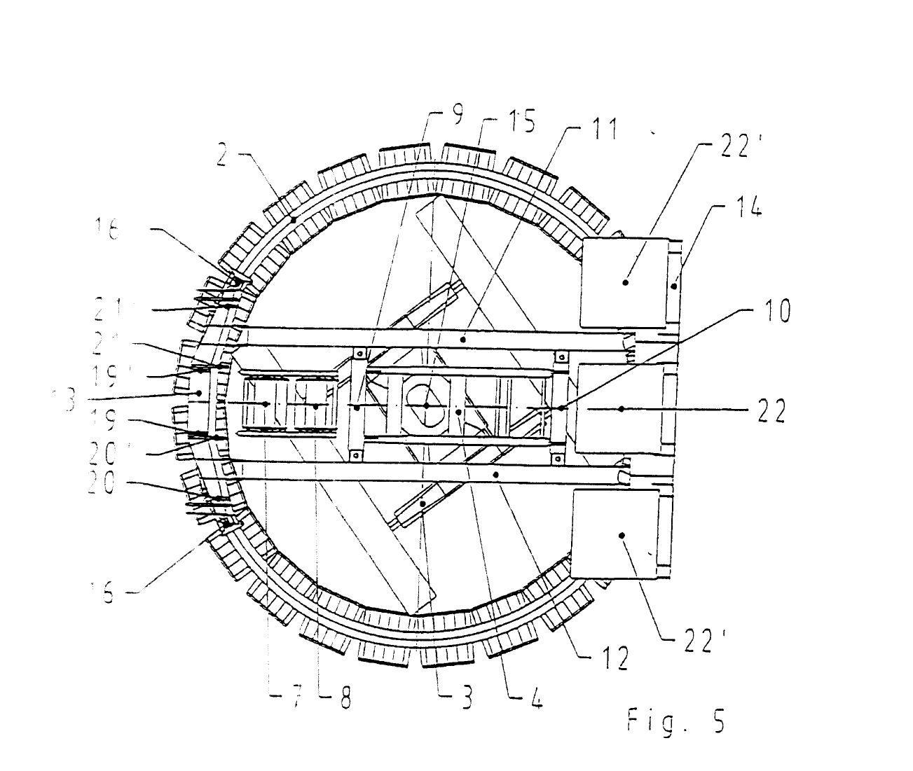

FIG. 4 is a view in enlarged scale showing the foot area of the main boom connected to the adapter;

FIG. 5 is a top view of the ring lift crane without boom.

FIG. 1 shows a perspective view of an embodiment example of a ring lift crane constructed according to the invention. It has a liftable ring 2 which is composed of individual segments, not shown, a chassis 3 on which a superstructure 4 is mounted so as to be rotatable is arranged within the ring 2. A plurality of winches 7, 8 are arranged in a row on the superstructure 4 (FIG. 5). In this embodiment example, the superstructure 4 is connected by cross-girders 9, 10 to two bridge girders 11, 12 which extend along the ring 2 parallel to one another. An adapter 13, 14 which is supported on the circular path of the ring 2 by rollers 16, 16′ which are indicated only schematically is provided in each end area of the two bridge girders 11, 12. The center 15 of the ring 2 and chassis 3 forms the axis of rotation for the superstructure 4. The adapter 13 shown at left in FIG. 5 serves to receive a main boom 17 and, in this embodiment example, a double-mast 18, 18′. Alternatively, an individual mast could also be provided with lateral reinforcement. The articulation points 19, 19′ for the main boom 17 and the articulation points 20, 20′, 21, 21′ for the double-mast 18, 18′ are shown in FIG. 5 at the adapter 13 located on the left-hand side. The adapter 14 located at right is constructed for receiving the counterweight 22, 22′.

In this embodiment example, the boom comprises the main boom 17 and the double-mast 18, 18′ already mentioned above. The double-mast 18, 18′ is connected on one side to the head piece 24 of the main boom 17 by an anchoring element 23 which can be adjusted in length and, on the other side, to the counterweight 22 by a fixed anchoring element 25, 25′.

According to the invention, the main boom 17 is provided with a lateral reinforcement (FIGS. 2 to 4). This lateral reinforcement comprises an anchoring

According to the invention, the main boom 17 is provided with a lateral reinforcement (FIGS. 2 to 4). This lateral reinforcement comprises an anchoring element 26, 26′ which is connected to the respective lattice element 28 of the main boom by connection elements 27, 27′. The two connection elements 27, 27′ form an isosceles triangle with the cross-member 29 arranged at the lattice element 28. The head end 30, 30′ of the lateral reinforcement is connected with the head piece 24 of the main boom 17. The foot end 31, 31′ is connected in an articulated manner with the front adapter 13.

1. Ring lift crane with a liftable ring forming a circular traveling path and having a plurality of segments which can be connected to one another, a chassis having a superstructure which is connected to the chassis so as to be rotatable and which is provided with a plurality of winches being arranged within the ring, which superstructure is provided with an adapter in each of two oppositely located end areas, and the adapters are supported so as to roll on the circular traveling path of the ring by rollers which are arranged in the end area of the adapters, wherein the center of the ring and chassis forms the axis of rotation and the rear adapter is constructed so as to receive a counterweight and the front adapter is constructed so as to receive a boom in the form of a lattice mast which can be articulated and which has at least one main boom, and means are provided for generating the rotating movement of the ring lift crane, and the chassis is connected with different portions of the ring by reinforcement members, characterized in that a lateral reinforcement is provided at least at one lattice mast component and extends along at least one half of the length of the lattice mast component.

2. Ring lift crane according to claim 1, characterized in that the main boom (17) has a lateral reinforcement whose foot end (31, 31′), like the foot end of the main boom (17), is connected in an articulated manner with the front adapter (13) and whose head end (30, 30′) is fixedly connected with an element of the main boom (17).

3. Ring lift crane according to claim 2, characterized in that the lateral reinforcement extends over the entire length of the main boom (17), and the head end (30, 30′) of the reinforcement is fixedly connected to the head piece (24) of the main boom (17).

4. Ring lift crane according to one of claims 1 to 3, characterized in that the lateral reinforcement comprises at least a right and a left anchoring element (26, 26″) arranged at a distance to and parallel to the lattice elements (28) of the respective lattice mast component and which is connected at defined distances to the respective lattice mast element (28) by connection elements (27, 27′).

5. Ring lift crane according to one of claims 1 to 4, characterized in that at least one connection element (27, 27′) is provided in a cross-sectional plane to the right and left of the lattice mast component.

6. Ring lift crane according to claim 5, characterized in that two connection elements (27, 27′) are provided on one side and the respective lattice element (28) has a cross-member (29) in this plane.

7. Ring lift crane according to claim 6, characterized in that the cross-member (29) and the two connection elements (27, 27′) form a triangle.

8. Ring lift crane according to claim 7, characterized in that the triangle an isosceles triangle.

9. Ring lift crane according to claim 7, characterized in that the distance to the adjacent cross-sectional plane is at least equal to or less than the length of the respective lattice mast element (28).

10. Ring lift crane according to claim 9, characterized in that the distance corresponds to one half of the length of the lattice mast element (28).

11. Ring lift crane according to one of claims 1 to 10, characterized in that the anchoring means (26, 26′) comprise bars or tubes which are connected to one another and whose length corresponds to the length of a lattice mast element (28).

12. Ring lift crane according to one of claims 1 to 10, characterized in that the anchoring means comprise a cable.

13. Ring lift crane according to one of claims 1 to 12, characterized in that the distance between the lattice mast element (28) and the anchoring means (26, 26′) in the cross-sectional plane corresponds to at least one half of the width of the lattice mast element (28).

14. Ring lift crane according to claim 13, characterized in that the distance corresponds to two to four times the width of the lattice mast element (28).

15. Ring lift crane according to one of claims 1 to 14, characterized in that the boom has a main boom (17) with lateral reinforcement and a double-mast (18, 18′) without lateral reinforcement, whose foot pieces are connected in an articulated manner to the front adapter (13) and whose head piece is connected, on the one side, to the head piece (24) of the main boom (17) via an anchoring element (23) whose length is adjustable and, on the other side, to the counterweight (22) via a fixed anchoring element (25, 25′).

16. Ring lift crane according to one of claims 1 to 4, characterized in that the boom has a double-main boom without lateral reinforcement and a fly jib with lateral reinforcement is arranged at the double-main boom.
